(19) United States
(12) Patent Application Publication
(10) Pub. No.: US 2026/0257803 A1
(43) Pub. Date: Sep. 3, 2026

(54) AIRCRAFT PROPULSION SYSTEM COMPRISING A TURBOMACHINE, A MOUNTING PYLON AND MEANS FOR ATTACHING THE TURBOMACHINE TO THE MOUNTING PYLON

(71) Applicant: Airbus Operations SAS, TOULOUSE (FR)

(72) Inventors: Olivier PAUTIS, TOULOUSE (FR); Lionel SILLIERES, TOULOUSE (FR); Simon VANDERBAUWEDE, TOULOUSE (FR); Nicolas CHARTON, TOULOUSE (FR); Julien VINOT, TOULOUSE (FR)

(21) Appl. No.: 19/549,122

(22) Filed: Feb. 25, 2026

(30) Foreign Application Priority Data
Feb. 28, 2025 (FR) FR2502070

(51) Int. Cl. B64D 27/40; B64D 27/18

(52) U.S. Cl. CPC B64D 27/404; B64D 27/18; B64D 27/402

(57) ABSTRACT

An aircraft propulsion system including a turbomachine including a front casing with a rear face and a rear casing, a mounting pylon with a front portion and to which a rear fitting is attached, an arch attached to the rear fitting and to the rear casing, and on either side of the vertical median plane, and a set of six connecting rods distributed on either side of the vertical median plane, each connecting rod being attached to the rear face of the front casing and to the arch, and the connecting rods converging towards each other at the arch in pairwise fashion.

### CROSS-REFERENCES TO RELATED APPLICATIONS

This application claims the benefit of French Patent Application Number FR2502070 filed on Feb. 28, 2025, the entire disclosures of which are incorporated herein by way of reference.

### FIELD OF THE INVENTION

The present invention relates to the general field of attaching a turbomachine beneath the wing of a plane. This notably concerns a propulsion system comprising a turbomachine, in particular a turbofan, a mounting pylon and means for attaching the turbomachine beneath the mounting pylon. It also applies to an aircraft equipped with such a propulsion system.

### BACKGROUND OF THE INVENTION

A propulsion system of the prior art is attached beneath the wing of an aircraft. It comprises a turbomachine and a mounting pylon via which the turbomachine is attached beneath the wing. The mounting pylon has a rigid structure, which is also referred to as the primary structure, with attachment means for attaching the turbomachine.

These attachment means are made up, among other things, of a front attachment for the turbomachine, of a rear attachment for the turbomachine and of a device for reacting the thrust forces generated by the turbomachine.

The mounting pylon also has other attachment elements for attaching the mounting pylon to the wing.

Although such a structure is satisfactory, it is desirable to find an alternative arrangement which makes it possible, among other things, to establish an isostatic connection between the turbomachine and the mounting pylon, while at the same time choosing the most suitable force paths.

### SUMMARY OF THE INVENTION

An object of the present invention is to propose a propulsion system comprising a turbomachine, a mounting pylon and means for attaching the turbomachine beneath the mounting pylon.

To this end, a propulsion system for an aircraft is proposed, the propulsion system comprising:

a turbomachine extending around a longitudinal axis and having a vertical median plane containing the longitudinal axis and comprising a front casing with a rear face perpendicular to the longitudinal axis and a rear casing,

a mounting pylon having a rigid structure with a front portion and a lower spar to which a rear fitting is attached,

a front engine mount which is attached between an upper portion of the front casing and the front portion of the rigid structure,

an arch with a base hinged to the rear fitting and two arms arranged one on each side of the vertical median plane, each arm having a first end secured to the base and a second end hinged to the rear casing,

two central connecting rods arranged one on each side of the vertical median plane, each central connecting rod being attached to the rear face of the front casing via a first central connecting point and to the arch via a second central connecting point, the two central connecting rods converging towards each other at the second central connecting points,

two port connecting rods arranged on a port side of the vertical median plane, each port connecting rod being attached to the rear face of the front casing via a first port connecting point and to the arch via a second port connecting point, the two port connecting rods converging towards each other at the second port connecting points,

two starboard connecting rods arranged on a starboard side of the vertical median plane, each starboard connecting rod being attached to the rear face of the front casing via a first starboard connecting point and to the arch via a second starboard connecting point, the two starboard connecting rods converging towards each other at the second starboard connecting points.

Such an arrangement makes it possible, among other things, to establish an isostatic connection between the turbomachine and the mounting pylon.

Advantageously, the rear fitting and the arch lie in a single plane of integration perpendicular to the longitudinal axis.

Advantageously, the central connecting rod on the port side of the vertical median plane and one of the port connecting rods converge towards each other at the corresponding first central connecting point and the corresponding first port connecting point.

Advantageously, the central connecting rod on the starboard side of the vertical median plane and one of the starboard connecting rods converge towards each other at the corresponding first central connecting point and the corresponding first starboard connecting point.

Advantageously, the propulsion system further comprises, on either side of the vertical median plane, a complementary connecting rod, each complementary connecting rod being attached to the rear face of the front casing via a first complementary connecting point and to the arch via a second complementary connecting point.

Advantageously, the complementary connecting rod on the port side of the vertical median plane and the other of the port connecting rods converge towards each other at the corresponding first port connecting point and the corresponding first complementary connecting point, and the complementary connecting rod on the starboard side of the vertical median plane and the other of the starboard connecting rods converge towards each other at the corresponding first starboard connecting point and the corresponding first complementary connecting point.

Advantageously, the base and the rear fitting are attached to each other, on one hand, by two rear connecting rods arranged symmetrically one on each side of the vertical median plane, each rear connecting rod being hinged to the rear fitting via a first connecting point and to the base via a second connecting point, and, on the other hand, on the vertical median plane, via a third connecting point connecting the base and the rear fitting.

Advantageously, the rear connecting rods lie in the plane of integration.

Advantageously, the second end of each arm and the rear casing are attached to each other by two pairs of link rods arranged symmetrically for each pair, with one pair on each side of the vertical median plane, each link rod lying in a plane perpendicular to the longitudinal axis, and each link rod being hinged to the second end of the arm that is on the same side via a first connecting point and to the rear casing via a second connecting point.

Advantageously, the link rods lie in the plane of integration.

Advantageously, for each pair of link rods, the two link rods are arranged symmetrically one on each side of a horizontal plane passing through the longitudinal axis.

Advantageously, the front engine mount has a front fitting attached to the front portion, two front connecting rods arranged symmetrically one on each side of the vertical median plane, and a vertical pin secured to the front fitting or to the front casing and fitted in a bore in the front casing or in the front fitting, respectively, each front connecting rod being hinged to the front fitting via a first connecting point and to the front casing via a second connecting point.

The invention relates to an aircraft comprising a propulsion system according to any of the preceding variants.

### BRIEF DESCRIPTION OF THE DRAWINGS

The above-mentioned features of the invention, along with others, will become more clearly apparent upon reading the following description of an exemplary embodiment, the description being given with reference to the appended drawings, in which:

FIG. 1 is a side view of an aircraft according to the invention,

FIG. 2 is a schematic perspective representation of a propulsion system according to the invention,

FIG. 3 is a sectional view along section plane III in FIG. 2, and

FIG. 4 is a sectional view along section plane IV in FIG. 2.

### DETAILED DESCRIPTION OF THE PREFERRED EMBODIMENTS

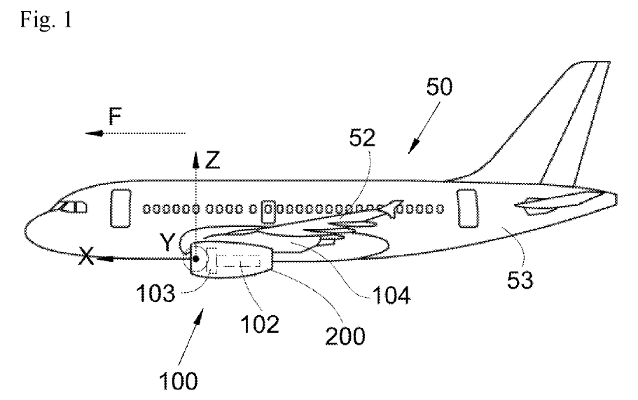

FIG. 1 shows an aircraft 50 that has a fuselage 53 on each side of which a wing 52 is attached. Attached beneath each wing 52 is a propulsion system 100 according to the invention, the propulsion system comprising a mounting pylon 104 and a turbomachine 102 which in this case is accommodated in a nacelle 200. The invention applies to any type of turbomachine 102, such as, for example, a turbofan or a turboprop with a non-ducted fan.

The propulsion system 100 is attached to the wing 52 by the mounting pylon 104 and the turbomachine 102 is attached beneath the mounting pylon 104.

By convention, X denotes the longitudinal axis of the turbomachine 102, this axis X being parallel to a longitudinal direction of this turbomachine 102 and to a longitudinal direction of the aircraft 50. Additionally, Y is the transverse axis of the turbomachine 102, this axis being horizontal when the aircraft 50 is on the ground, and Z is the vertical axis or vertical height when the aircraft 50 is on the ground, these three axes X, Y and Z being mutually orthogonal.

Furthermore, the terms “front” and “rear” are to be considered relative to a direction of forward movement of the aircraft 50 when the turbomachine 102 is operating, this direction being schematically shown by the arrow F.

The turbomachine 102 and the mounting pylon 104 are symmetrical overall with respect to a vertical median plane P (XZ) containing the longitudinal axis X and thus the vertical direction Z. The transverse axis Y is perpendicular to the vertical median plane P.

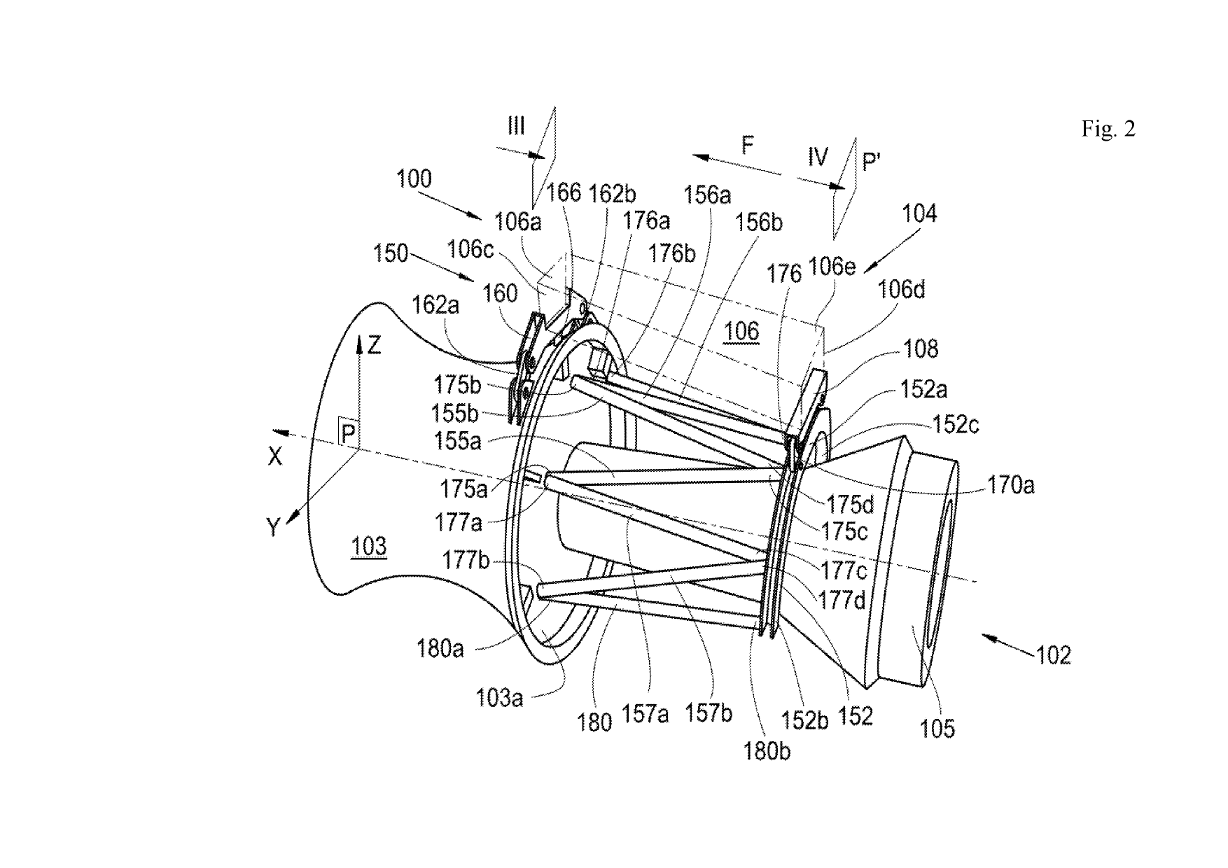

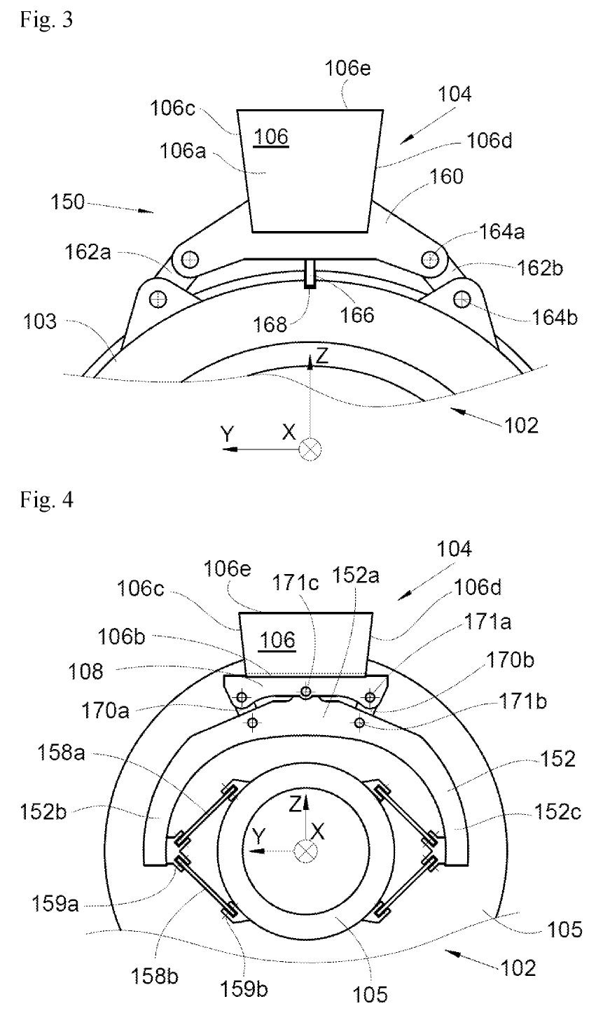

FIG. 2 shows the propulsion system 100 according to the invention and FIGS. 3 and 4 show embodiment details of the propulsion system 100.

The propulsion system 100 comprises the turbomachine 102 and the mounting pylon 104 which attaches the turbomachine 102 to the wing 52. The mounting pylon 104 is represented here by its rigid structure 106, also referred to as primary structure, that is attached to the structure of the wing 52 by any suitable securing means known to those skilled in the art.

The rigid structure 106 takes the form of a box which comprises a front portion 106a, located at the front of the rigid structure 106, a lower spar 106b extending below the rigid structure 106 and an upper spar 106e extending above the rigid structure 106. The rigid structure 106 also comprises two lateral walls 106c-d, one on each side of the vertical median plane P. These various spars and walls are attached to each other to form the rigid structure 106. The front portion 106a comprises, for example, a front wall and a portion of the lower spar 106b and of the lateral walls 106c-d.

The turbomachine 102 comprises the following, from front to rear: a front casing 103 and a rear casing 105 which is attached to the rear of the front casing 103 and which accommodates elements of the turbomachine 102, such as compression stages, a combustion chamber, turbine stages and an exhaust cone. The front casing 103 is, for example, a fan casing in which a fan of the turbomachine 102 is mounted, but may also be the casing which is just to the rear of the fan in the case of a turbomachine with a non-ducted fan. The front casing 103 has a diameter greater than the diameter of the rear casing 105.

At the rear, the front casing 103 has a rear face 103a which is perpendicular to the longitudinal axis X and thus extends in a plane parallel to the plane YZ. The front casing 103 and the rear casing 105 form surfaces of revolution about the longitudinal axis X.

The propulsion system 100 comprises a front engine mount 150 which attaches an upper portion of the front casing 103 to the front portion 106a of the rigid structure 106.

The propulsion system 100 also comprises an arch 152 arranged around the rear casing 105 and to the rear of the rear surface 103a of the front casing 103. A rear fitting 108 is rigidly attached to the lower spar 106b beneath the rigid structure 106.

The arch 152 has a base 152a which is hinged to the rear fitting 108. The arch 152 also has two arms 152b-c arranged one on each side of the vertical median plane P, i.e., symmetrically with respect to the vertical median plane P; there is a port-side arm 152b and a starboard-side arm 152c. Each arm 152b-c has a first end secured to the base 152a and a second end hinged to the rear casing 105. Each arm 152b-c may be an element attached to the base 152a or form a one-piece assembly with the base 152a. The arch 152 has, parallel to the longitudinal axis X, a thickness E which is dimensioned so as to withstand the forces passing through it as in the rear attachments of the prior art. The thickness E is distributed on either side of a plane of integration P’.

In the embodiment of the invention shown in FIG. 2, the second ends of each arm 152b-c of the arch 152 are respectively at 3 o’clock and 9 o’clock with respect to the longitudinal axis X. However, the positions of the second ends of each arm 152b-c of the arch 152 may be arranged at +/- 45° with respect to these positions shown.

The propulsion system 100 also comprises six connecting rods which are distributed on either side of the vertical median plane P.

There are thus two central connecting rods 155a-b which are arranged one on each side of the vertical median plane P, and there is, therefore, a central connecting rod 155a on the port side and a central connecting rod 155b on the starboard side.

Each central connecting rod 155a-b is attached by one of its ends to the rear face 103a of the front casing 103 via a first central connecting point 175a-b and by the other of its ends to the arch 152 via a second central connecting point 175c-d.

The two central connecting rods 155a-b converge towards each other at the second central connecting points 175c-d which are at the arch 152, that is to say, the second central connecting points 175c-d are concentrated at the same place just in front of the arch 152. In other words, according to the invention, the two central connecting rods 155a-b converge towards each other in a central convergence zone which is just in front of the arch 152 when, parallel to the longitudinal axis X, the central convergence zone is located at a maximum distance equal to 1.5 times the thickness of the arch 152 in front of the plane of integration P’.

There are thus two port connecting rods 157a-b which are arranged on the port side of the vertical median plane P and each port connecting rod 157a-b is attached by one of its ends to the rear face 103a of the front casing 103 via a first port connecting point 177a-b and by the other of its ends to the arch 152 via a second port connecting point 177c-d.

The two port connecting rods 157a-b converge towards each other at the second port connecting points 177c-d which are at the arch 152, that is to say, the second port connecting points 177c-d are concentrated at the same place just in front of the arch 152. In other words, according to the invention, the two port connecting rods 157a-b converge towards each other in a port convergence zone which is just in front of the arch 152 when, parallel to the longitudinal axis X, the port convergence zone is located at a maximum distance equal to 1.5 times the thickness of the arch 152 in front of the plane of integration P’.

There are lastly two starboard connecting rods 156a-b which are arranged on the starboard side of the vertical median plane P and each starboard connecting rod 156a-b is attached by one of its ends to the rear face 103a of the front casing 103 via a first starboard connecting point 176a-b and by the other of its ends to the arch 152 via a second starboard connecting point 176. In FIG. 2, only the second starboard connecting point 176 of the starboard connecting rod 156a is visible.

The two starboard connecting rods 156a-b converge towards each other at the second starboard connecting points 176 which are at the arch 152, that is to say, the second starboard connecting points 176 are concentrated at the same place just in front of the arch 152. In other words, according to the invention, the two starboard connecting rods 156a-b converge towards each other in a starboard convergence zone which is just in front of the arch 152 when, parallel to the longitudinal axis X, the starboard convergence zone is located at a maximum distance equal to 1.5 times the thickness of the arch 152 in front of the plane of integration P’.

Two connecting rods converge when their axes intersect at a convergence zone.

Such a propulsion system 100 thus makes it possible to establish an isostatic connection between the turbomachine and the mounting pylon by way of various attachment elements while ensuring the redundancy of the connections for safety purposes.

The points of connection with the arch 152 are close to the arch 152. The convergence zone of the two central connecting rods 155a-b at the arch 152 is at the vertical median plane P. The convergence zone, at the arch 152, of the two port connecting rods 157a-b, respectively of the two starboard connecting rods 156a-b, is between 7 o’clock and 9 o’clock on the port side and between 3 o’clock and 5 o’clock on the starboard side when viewed from behind.

Each of the connecting points can take the form of an encastre connection or a ball-joint connection. Each connecting point which is not embedded in encastre fashion takes the form of a clevis connection, for example. Each encastre connection is achieved, for example, by welding, force-fitting, clamping using a screw-nut system, etc.

In the embodiment of the invention shown in FIG. 2, the rear fitting 108 and the arch 152 lie in the single mean plane of integration P’ which is perpendicular to the longitudinal axis X.

In the embodiment of the invention shown in FIG. 2, the central connecting rod 155a which is on the port side of the vertical median plane P and one of the port connecting rods 157a converge towards each other at the corresponding first central connecting point 175a and the corresponding first port connecting point 177a, that is to say that these two connecting points 175a and 177a are concentrated at the same place and their axes intersect at a convergence zone at the rear face 103a of the front casing 103 which, when viewed from behind, is between 10 o’clock and 11 o’clock.

In the same way, here, the central connecting rod 155b which is on the starboard side of the vertical median plane P and one of the starboard connecting rods 156a converge towards each other at the corresponding first central connecting point 175b and the corresponding first starboard connecting point 176a, that is to say, these two connecting points 175b and 176a are concentrated at the same place and their axes intersect at a convergence zone at the rear face 103a of the front casing 103 which, when viewed from behind, is at 12 o’clock.

In order to further increase the stiffness of the propulsion system 100, in particular about an axis perpendicular to the longitudinal axis X, the propulsion system 100 further comprises, on either side of the vertical median plane P, a complementary connecting rod 180. There is, therefore, a complementary connecting rod 180 on the port side and a complementary connecting rod 180 on the starboard side. Each complementary connecting rod 180 is attached by one of its ends to the rear face 103a of the front casing 103 via a first complementary connecting point 180a and by the other of its ends to the arch 152 via a second complementary connecting point 180b.

As above, each of the complementary connecting points 180a-b can take the form of an encastre connection or a ball-joint connection.

In the embodiment of the invention shown here, the complementary connecting rod 180 which is on the port side of the vertical median plane P and the port connecting rod 157a which does not converge with the central connecting rod 155a on the port side converge towards each other at the corresponding first port connecting point 177b and the corresponding first complementary connecting point 180a, that is to say, these two connecting points 177b and 180a are concentrated at the same place and their axes intersect at a convergence zone at the rear face 103a of the front casing 103. The two connecting points 177b and 180a are around the 3 o’clock to 5 o’clock zone.

In the same way, the complementary connecting rod 180 which is on the starboard side of the vertical median plane P and the starboard connecting rod 156b which does not converge with the central connecting rod 155b on the starboard side converge towards each other at the corresponding first starboard connecting point 176b and the corresponding first complementary connecting point 180a, that is to say, these two connecting points 176b and 180a are concentrated at the same place and their axes intersect at a convergence zone at the rear face 103a of the front casing 103. The two connecting points 176b and 180a are around the 9 o’clock to 7 o’clock zone.

FIG. 4 more clearly shows an example of the attachment between the base 152a of the arch 152 and the rear fitting 108. This attachment is realized by two rear connecting rods 170a-b and by a third connecting point 171c which is a backup connecting point, that is to say, it only activates if one of the rear connecting rods 170a-b fails.

The two rear connecting rods 170a-b are arranged symmetrically one on each side of the vertical median plane P and each rear connecting rod 170a-b is hinged to the rear fitting 108 via a first connecting point 171a and to the base 152a via a second connecting point 171b. Each connecting point 171a-b connected to the rear connecting rods 170a-b takes at least the form of a pivot connection, but preferably takes the form of a ball-joint connection for limiting the bending moments and each connecting point in this case has a main axis of rotation which is parallel to the longitudinal axis X.

The third connecting point 171c connects the base 152a to the rear fitting 108 and is arranged on the vertical median plane P. This third connecting point 171c takes at least the form of a pivot connection, but preferably takes the form of a ball-joint connection for limiting the bending moments and in this case has a main axis of rotation which is parallel to the longitudinal axis X.

In the embodiment of the invention shown here, the rear connecting rods 170a-b lie in the plane of integration P’.

Each connecting point 171a-c takes the form of a clevis connection in this case.

In the case of the third connecting point 171c, the pin of the clevis connection has a diameter slightly less than the diameter of the bores in which it is fitted such that it only comes into contact with the bores when necessary.

FIG. 4 also shows a particular embodiment of the attachment between the second end of each arm 152b-c and the rear casing 105. This attachment is realized by two pairs of link rods 158a-b, the pairs being arranged symmetrically one on each side of the vertical median plane P and each link rod 158a-b lying in a plane perpendicular to the longitudinal axis X which is also the plane in which the arch 152 lies.

Each link rod 158a-b is hingedly and removably attached to the second end of the arm 152a-b that is on the same side via a first connecting point 159a and to the rear casing 105 via a second connecting point 159b.

In this case, for each pair of link rods 158a-b, the two link rods 158a-b are arranged symmetrically one on each side of a horizontal plane passing through the longitudinal axis X, that is to say, the plane XY. The symmetrical fitting in place makes it possible to position the rear casing 105 relative to the arch 152.

Each connecting point 159a-b connected to the link rods 158a-b takes at least the form of a pivot connection, but preferably takes the form of a ball-joint connection for limiting the bending moments and each of these connecting points 159a-b in this case has a main axis of rotation which is perpendicular to the axis of the link rod 158a-b in question and lies in a plane which is perpendicular to the longitudinal axis X and is also the plane in which the arch 152 lies.

Each connecting point 159a-b takes the form of a clevis connection in this case.

In the embodiment of the invention shown here, the link rods 158a-b lie in the plane of integration P’.

FIG. 3 more clearly shows an example of a front engine mount 150 implemented in the invention, but the engine mount 150 can have a different architecture.

The front engine mount 150 has a front fitting 160 attached to the front portion 106a and two front connecting rods 162a-b arranged symmetrically one on each side of the vertical median plane P. Each front connecting rod 162a-b is hinged to the front fitting 160 via a first connecting point 164a and to the front casing 103 via a second connecting point 164b. Each connecting point 164a-b connected to the front connecting rods 162a-b takes at least the form of a pivot connection, but preferably takes the form of a ball-joint connection for limiting the bending moments and each connecting point in this case has a main axis of rotation which is parallel to the longitudinal axis X. Each connecting point 164a-b takes the form of a clevis connection in this case.

The front engine mount 150 also has a connection of the “spigot” type with a pin 166 which extends vertically, that is to say, parallel to the vertical axis Z, and lies in the vertical median plane P.

The pin 166 is secured to the front fitting 160 or to the front casing 103 and is fitted, as the case may be, in a bore 168 in the front casing 103 or in the front fitting 160.

The fit between the bore 168 and the pin 166 is such that there is no movement along the longitudinal axis X or along the transverse axis Y, only movements along the vertical axis Z.

The three convergence zones, namely that of the second central connecting points 175c-d, that of the second port connecting points 177c-d and that of the second starboard connecting points 176, are not aligned on a straight line perpendicular to the vertical median plane P.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A propulsion system for an aircraft, said propulsion system comprising:
a turbomachine extending around a longitudinal axis and having a vertical median plane containing the longitudinal axis and comprising a front casing with a rear face perpendicular to the longitudinal axis and a rear casing,
a mounting pylon having a rigid structure with a front portion and a lower spar to which a rear fitting is attached,
a front engine mount which is attached between an upper portion of the front casing and the front portion of the rigid structure,
an arch with a base hinged to the rear fitting and two arms arranged one on each side of the vertical median plane, each arm having a first end secured to the base and a second end hinged to the rear casing,
two central connecting rods arranged one on each side of the vertical median plane, each central connecting rod being attached to the rear face of the front casing via a first central connecting point and to the arch via a second central connecting point, the two central connecting rods converging towards each other at the second central connecting points,
two port connecting rods arranged on a port side of the vertical median plane, each port connecting rod being attached to the rear face of the front casing via a first port connecting point and to the arch via a second port connecting point, the two port connecting rods converging towards each other at the second port connecting points, and
two starboard connecting rods arranged on a starboard side of the vertical median plane, each starboard connecting rod being attached to the rear face of the front casing via a first starboard connecting point and to the arch via a second starboard connecting point, the two starboard connecting rods converging towards each other at the second starboard connecting points.

2. The propulsion system according to claim 1, wherein the rear fitting and the arch lie in a single plane of integration perpendicular to the longitudinal axis.

3. The propulsion system according to claim 1, wherein the central connecting rod on the port side of the vertical median plane and one of the port connecting rods converge towards each other at the corresponding first central connecting point and the corresponding first port connecting point.

4. The propulsion system according to claim 1, wherein the central connecting rod on the starboard side of the vertical median plane and one of the starboard connecting rods converge towards each other at the corresponding first central connecting point and the corresponding first starboard connecting point.

5. The propulsion system according to claim 1, further comprising, on either side of the vertical median plane, a complementary connecting rod, each complementary connecting rod being attached to the rear face of the front casing via a first complementary connecting point and to the arch via a second complementary connecting point.

6. The propulsion system according to claim 3,
wherein the central connecting rod on the starboard side of the vertical median plane and one of the starboard connecting rods converge towards each other at the corresponding first central connecting point and the corresponding first starboard connecting point,
further comprising, on either side of the vertical median plane, a complementary connecting rod, each complementary connecting rod being attached to the rear face of the front casing via a first complementary connecting point and to the arch via a second complementary connecting point,
wherein the complementary connecting rod on the port side of the vertical median plane and the other of the port connecting rods converge towards each other at the corresponding first port connecting point and the corresponding first complementary connecting point, and
wherein the complementary connecting rod on the starboard side of the vertical median plane and the other of the starboard connecting rods converge towards each other at the corresponding first starboard connecting point and the corresponding first complementary connecting point.

7. The propulsion system according to claim 1, wherein the base and the rear fitting are attached to each other, firstly, by two rear connecting rods arranged symmetrically one on each side of the vertical median plane, each rear connecting rod being hinged to the rear fitting via a first connecting point and to the base via a second connecting point, and, secondly, on the vertical median plane, via a third connecting point connecting the base and the rear fitting.

8. The propulsion system according to claim 2,
wherein the base and the rear fitting are attached to each other, firstly, by two rear connecting rods arranged symmetrically one on each side of the vertical median plane, each rear connecting rod being hinged to the rear fitting via a first connecting point and to the base via a second connecting point, and, secondly, on the vertical median plane, via a third connecting point connecting the base and the rear fitting, and
wherein the rear connecting rods lie in the plane of integration.

9. The propulsion system according to claim 1, wherein the second end of each arm and the rear casing are attached to each other by two pairs of link rods arranged symmetrically for each pair, with one pair on each side of the vertical median plane, each link rod lying in a plane perpendicular to the longitudinal axis, and each link rod being hinged to the second end of the arm that is on the same side via a first connecting point and to the rear casing via a second connecting point.

10. The propulsion system according to claim 2,
wherein the second end of each arm and the rear casing are attached to each other by two pairs of link rods arranged symmetrically for each pair, with one pair on each side of the vertical median plane, each link rod lying in a plane perpendicular to the longitudinal axis, and each link rod being hinged to the second end of the arm that is on the same side via a first connecting point and to the rear casing via a second connecting point, and
wherein the link rods lie in the plane of integration.

11. The propulsion system according to claim 9, wherein, for each pair of link rods, the two link rods are arranged symmetrically one on each side of a horizontal plane passing through the longitudinal axis.

12. The propulsion system according to claim 1, wherein the front engine mount has a front fitting attached to the front portion, two front connecting rods arranged symmetrically one on each side of the vertical median plane, and a vertical pin secured to the front fitting or to the front casing and fitted in a bore in the front casing or in the front fitting, respectively, each front connecting rod being hinged to the front fitting via a first connecting point and to the front casing via a second connecting point.

13. An aircraft comprising a propulsion system according to claim 1.
